(19) United States
(12) Patent Application Publication
(10) Pub. No.: US 2007/0133439 A1
(43) Pub. Date: Jun. 14, 2007

(54) Method and apparatus to facilitate transferring chairmanship of an ad-hoc conference call

(76) Inventors: Edgardo L. Promenzio, Round Lake, IL (US); Yi-Cheng Liu, Barrington, IL (US); Rajendra A. Panchal, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/301,143

(22) Filed: Dec. 12, 2005

(51) Int. Cl. H04Q 11/00

(52) U.S. Cl. 370/261; 370/338

(57) ABSTRACT

One detects (101) an indication from an initiator of a presently supported ad-hoc conference call who seeks to transfer chairmanship of the presently supported ad-hoc conference call to another conference call participant. The chairmanship is then transferred (102) to this other participant to thereby provide a presently supported ad-hoc conference call having a transferred chairman.

### RELATED APPLICATIONS

Two co-pending applications as were filed on even date herewith contain related subject matter (the full contents of which are incorporated herein by this reference). These two co-pending applications are:

METHOD AND APPARATUS TO FACILITATE USE OF A SESSION INITIATION PROTOCOL INSTANCE TO SUPPORT ON-HOLD SESSION STATUS bearing attorney docket number CE15139R;

METHOD AND APPARATUS TO FACILITATE PERSISTENCE OF A HANDED-OFF COMMUNICATION SESSION bearing attorney docket number CE15112R.

### TECHNICAL FIELD

This invention relates generally to communication systems and more particularly to ad-hoc conference calls.

### BACKGROUND

Communication networks of various kinds are known. A communication session typically comprises the facilitation of communications between two or more user platforms. One category of communication session is generally known as an ad-hoc conference call. In an ad-hoc conference call, typically three or more user platforms are able to communicate in a substantially joined manner using a conference call resource that has been set up in response to ad-hoc initiation of the conference call by an initiating user platform. Multiple users can listen while one user speaks and then the opportunity to speak can pass to another one of the listening users.

Generally speaking, an ad-hoc conference call will automatically terminate when the user platform that initiated the ad-hoc conference call leaves the call for any reason. This approach can aid with preserving the exclusiveness of the conference itself in the event the initiator unexpectedly drops out of the call session (due, for example, to a sudden loss of a bearer channel as may occur during periods of mobility). Such an approach can also aid with managing costs as correspond to the ad-hoc conference call; when the initiator terminates their own participation they can presume that a corresponding cost of maintaining the ad-hoc conference call will also conclude at that point due to automatic termination of the ad-hoc conference call.

Such an approach, however, does not necessarily serve all potential needs. There are times, for example, when an initiator may wish for an ad-hoc conference call to persist notwithstanding their own lack of future participation. For example, the initiating party may need to momentarily leave the ad-hoc conference call in order to participate in another call and an on-hold facility may be unavailable or inappropriate for use. Automatically terminating the ad-hoc conference call in such an instance will require the returning party to effectively re-create the call session in order to resume the conference.

Simply persisting an ad hoc conference call in the absence of the initiating party, however, can lead to problems as well. As one simple example already alluded to above, such a practice may lead to a loss of control with respect to the ongoing costs of maintaining the ad hoc conference call. This, in turn, could dissuade a user from opting for such a capability notwithstanding their dissatisfaction with the status quo.

### BRIEF DESCRIPTION OF THE DRAWINGS

The above needs are at least partially met through provision of the method and apparatus to facilitate transferring chairmanship of an ad-hoc conference call described in the following detailed description, particularly when studied in conjunction with the drawings, wherein:

FIG. 1 comprises a flow diagram as configured in accordance with various embodiments of the invention;

FIG. 2 comprises a schematic view of a message header as configured in accordance with various embodiments of the invention;

FIG. 3 comprises a block diagram as configured in accordance with various embodiments of the invention;

FIG. 4 comprises a flow diagram as configured in accordance with various embodiments of the invention;

FIG. 5 comprises a flow diagram as configured in accordance with various embodiments of the invention; and

FIG. 6 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one detects an indication from an initiator of a presently supported ad-hoc conference call who seeks to transfer chairmanship of the presently supported ad-hoc conference call to another conference call participant. The chairmanship is then transferred to this other participant to thereby provide a presently supported ad-hoc conference call having a transferred chairman.

By one approach, and having completed such a transfer, the initiator of the ad-hoc conference call can be permitted to leave the presently supported ad-hoc conference call without terminating the ad-hoc conference call. If desired, one may further provide for permitting the initiator to return to the presently supported ad-hoc conference call and, upon satisfying at least on predetermined requirement, permit the initiator to regain chairman status. By one approach such a transfer can be conditioned by one or more constraints of choice to thereby limit in various ways the scope of the new chairman's rights and authority.

So configured, those skilled in the art will understand and appreciate that an ad-hoc conference call initiator can persist, when they chose, the duration and support of an ad-hoc conference call subsequent to their own absence from that ad-hoc conference call. As these teachings permit the initiator in such a circumstance to select and target the new chairman, the initiating user can feel at least some degree of confidence with respect to some control and responsibility regarding duration and conduct of the conference being maintained in their absence. These teachings are relatively simple to implement and can, if desired, be readily embodied by appropriate leveraging of legacy protocols and platforms. Those skilled in the art will further recognize and appreciate that these teachings are implementable without requiring interaction with a network element such as a policy server as may typify certain prior art suggestions such as those associated with presented in certain cellular telephony standards.

These and other benefits may become clearer upon making a thorough review and study of the following detailed description. Referring now to the drawings, and in particular to FIG. 1, a corresponding process 100 can be implemented by a network element such as, but not limited to, a conference FOCUS network element as is known in the art. Other implementing platforms may be used as well in accordance with the needs and/or requirements of a given application setting.

This process 100 provides for detecting 101 an indication from an initiator of a presently supported ad-hoc conference call seeking to transfer chairmanship of the presently supported ad-hoc conference call to another participant of the presently supported ad-hoc conference call. Those skilled in the art will understand that such an ad-hoc conference call may comprise at least one communication leg that itself comprises a wireless communication leg (where the bearer resource comprises, for example, a cellular telephony channel or the like). Such detection can comprise, if desired, receiving a message at the network element such as, but not limited to, a REFER message as was sourced by the initiator of the presently supported ad-hoc conference call. Such a REFER message may identify, for example, another ad-hoc conference call participant to whom the chairmanship is to be transferred while also providing an identifier for the initiator itself.

If desired, this message (or a corresponding subsequent message) can also provide additional transfer-related information such as specific constraints and/or restrictions as are to be imposed with respect to the transfer of the chairmanship status and role. Such restrictions may relate, for example, to a maximum time limit for the conference call, to a minimum number of participants who must remain engaged in the ad-hoc conference call before the ad-hoc conference call will be automatically terminated, to whether and/or to whom the new chairman may then themselves again transfer the chairmanship role to yet another participating party, and so forth.

Those skilled in the art will recognize and understand that such a message may be received relatively directly from the ad-hoc conference call initiator or may, for example, be received more indirectly as when a proxy (such as a Session Initiation Protocol proxy as is known in the art) serves as a message forwarding intermediary.

This process 100 then provides for transferring 103 chairmanship of the presently supported ad-hoc conference call to the identified participant to provide a presently supported ad-hoc conference call having a transferred chairman. This transfer can be effected, for example and at least in part, by directing a message from the network element to the targeted participant (where such a message can comprise, for example and not by way of limitation, a Session Initiation Protocol-compatible message such as a RE-INVITE message). This message can comprise such information as may be useful in a given application setting to effect the desired transfer of chairmanship status.

To illustrate, and referring momentarily to FIG. 2, such messages (as are provided to or sourced from the network element) can comprise a header 200 that itself presents information regarding, for example, identification 201 of the initiator and/or a present chairman of the presently supported ad-hoc conference call, identification 202 of the ad-hoc conference call participant to whom the chairmanship is to be transferred, and/or one or more restrictions 203 as may correspond to the transfer of the chairmanship to the new party.

So configured, a chairmanship role can be readily transferred from an initiating user to another participant in a relatively simple, effective, and reliable manner. These teachings further provide great flexibility and security with respect to ensuring that the transferring user can select a particular transferee to only be the allowed recipient of the chairmanship role. Furthermore, it can be readily understood that these teachings permit a given transferring party to selectively encumber the transferred chairmanship status with limits and restrictions in a way that supports the intentions of the transferring party.

Another potential advantage, and referring again to FIG. 1, is that this process 100 will readily (though optionally) accommodate permitting 103 an initiator who has transferred chairmanship as described herein to leave the presently supported ad-hoc conference call without terminating that ad-hoc conference call as might otherwise occur when applying prior art practices in this regard. Instead, the ad-hoc conference call can continue to be supported using the new chairman as the ongoing chairman.

As a further optional embellishment, these teachings will further accommodate (following, for example, detection 104 of the return of an ad-hoc conference call initiator to a still ongoing ad-hoc conference call) determining 105 whether a returning ad-hoc conference call initiator satisfies at least one predetermined requirement and, when true, permitting 106 that returning initiator to regain their chairman status. This can be accomplished in various ways including via corresponding messaging as sourced by the network element to and between the present chairman and the returning initiator.

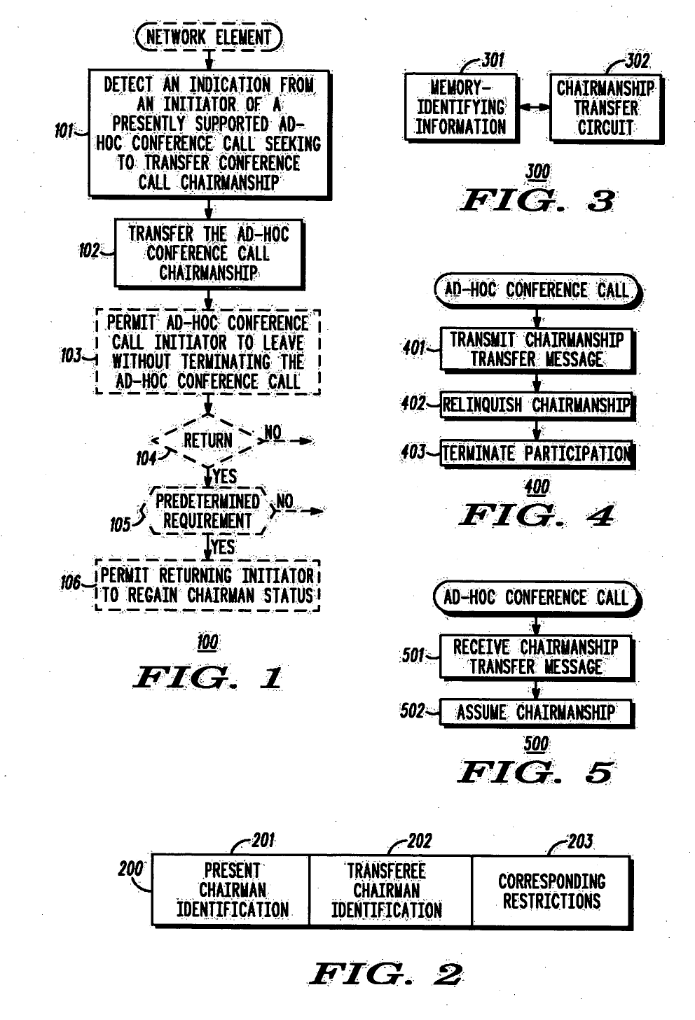

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment the network element 300 may comprise, for example, a Session Initiation Protocol-compatible conference FOCUS network element as is known in the art that comprises, here, a memory 301 and a chairmanship transfer circuit 302 that operably couples thereto. The memory 301 has, via this approach, identifying information stored therein as has been received from a present chairman of a presently supported ad-hoc conference call along with identifying information regarding another participant of that ad-hoc conference call (which latter identifying information may also have been provided by the present chairman as per the teachings set forth herein).

The chairmanship transfer circuit, in turn, is appropriately configured and arranged (via, for example, corresponding programming of a programmable platform in accordance with the teachings set forth herein) to transfer the chairmanship role for the presently supported ad-hoc conference call from the present chairman to the other participant as is identified in the contents of the memory 301. So configured, for example, the chairmanship transfer circuit 302 serves to detecting indications from the present chairman that the latter seeks to transfer the chairmanship to this other participant and to also effect transferring that chairmanship role to the latter in order to thereby provide a presently supported ad-hoc conference call that now has a transferred chairman.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

By one approach at least some participating user platforms interact with such a network element to initiate and/or effect such practices. Referring now to FIG. 4, this can comprise a process 400, for example, that provides for transmitting 401 (during participation in a presently supported ad-hoc conference call as a conference call chairman) at least one message (such as a message as is described above) to facilitate transferring chairmanship of the presently supported ad-hoc conference call to another participant of that ad-hoc conference call. This process 400 can further provide for thereafter relinquishing 402 the chairmanship role with respect to the presently supported ad-hoc conference call and even, if desired, accommodating terminating 403 participation in the presently supported ad-hoc conference call without also thereby effecting termination of the presently supported ad-hoc conference call. Such a process 400, of course, aids in facilitating surrendering and/or reassigning the chairmanship role.

By another approach, and referring now to FIG. 5, a user platform can facilitate receiving a transferred chairmanship role via a process 500 that provides for receiving 501 a message that indicates a transfer of chairmanship of the presently supported ad-hoc conference call and for corresponding assumption 502 of that transferred chairmanship role. Again, such a message can be composed as taught above and further can optionally include one or more restrictions with respect to how, or for how long, the recipient user platform can exercise and wield the chairmanship position.

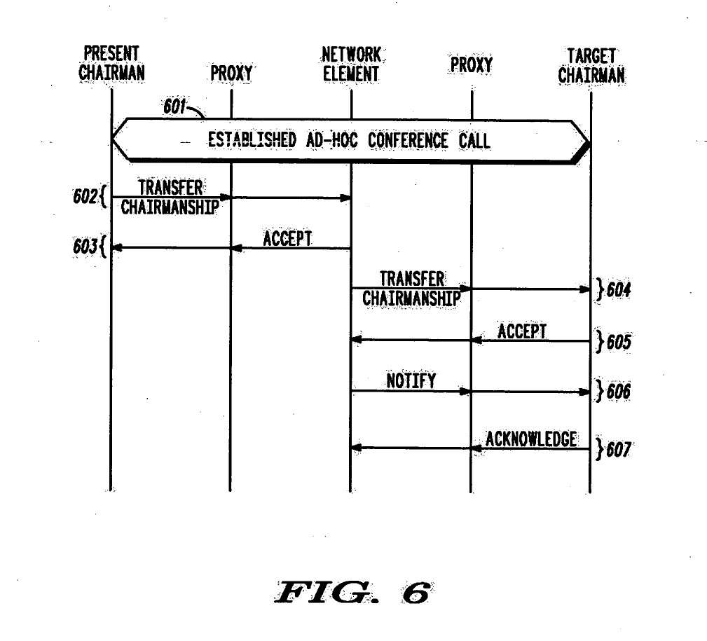

There are various says by which such teachings may be realized in a given setting. To provide but one non-exhaustive illustrative example, and referring now to FIG. 6, a present chairman may be engaged in a presently established ad-hoc conference call with a target chairman and other (not shown) user platforms. By these teachings the present chairman (which may, or may not, be the original initiator of this ad-hoc conference call) sources a transfer chairmanship message 602 (such as, but not limited to, a REFER message that identifies the target chairman and that further specifies a corresponding action such as signaling a conference privilege transfer via a message header or other message portion as may usefully convey such content). In this illustrative embodiment this message 602 is directed to a network element (such as a Session Initiation Protocol-compatible conference FOCUS network element) via a proxy (such as a Session Initiation Protocol proxy as is known in the art) in accordance with well-understood prior art practice in this general regard.

The network element signals its acceptance via an acceptance message 603 (which may comprise, for example, a 2020K message as is known in the art). This network element, in accordance with these teachings, then transmits a transfer chairmanship message 604 that may comprise, for example, a RE-INVITE message having a privilege header as described above (specifying, for example, the identity of the original chairman, the target chairman, one or more restrictions (which may of course be expressed as permitted privileges), and so forth).

In this illustrative example the target chairman responds with an accept message 605 (such as a 200 OK message that is forwarded from the target chairman to the network element via an intervening proxy). The network element then sources a NOTIFY message 606 (to thereby effect implicit subscription of conference state notification on behalf of the target chairman) to which the target chairman (now, of course, the new chairman) may respond with an acknowledge message 607 (such as, again, a 200 OK message).

So configured, those skilled in the art will recognize and appreciate that these teachings, while relatively simple to implement and convenient to apply, facilitate great flexibility with respect to the on-going conduct of an ad-hoc conference call. Various benefits potentially accrue by leveraging this core ability to transfer chairmanship during the course of a presently supported ad-hoc conference call. Such benefits include, but are not limited to, the ability to now permit an ad-hoc conference call initiator to leave a presently supported ad-hoc conference call without causing that conference call to be terminated as a directly related consequence. Such benefits further include the ability to permit a returning initiator to regain the chairmanship role notwithstanding their having transferred the role to another during the course of that same ad-hoc conference call.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, if desired, provision can be made to permit a candidate chairman user platform to decline transfer of the chairmanship position (as may be appropriate, for example, when the identified transferee is about to also leave the ad-hoc conference call). Depending upon the needs and/or capabilities of a given application setting, one might also wish to facilitate transferring the chairmanship role from a single user platform to multiple platforms (thereby creating a co-chairmanship scenario) where, for example, different chairmanship capabilities might be parsed amongst a plurality of co-chairman user platforms.

We claim:

1. A method comprising:
detecting an indication from an initiator of a presently supported ad-hoc conference call seeking to transfer chairmanship of the presently supported ad-hoc conference call to another participant of the presently supported ad-hoc conference call;
transferring chairmanship of the presently supported ad-hoc conference call to the another participant to provide a presently supported ad-hoc conference call having a transferred chairman.

2. The method of claim 1 wherein the presently supported ad-hoc conference call comprises at least one communication leg that comprises a wireless communication leg.

3. The method of claim 1 wherein detecting an indication comprises receiving a message at a conference focus network element.

4. The method of claim 3 wherein detecting an indication comprises receiving a message at a conference focus network element wherein the message comprises a REFER message as was sourced by the initiator of the presently supported ad-hoc conference call.

5. The method of claim 4 wherein receiving a REFER message comprises receiving a REFER message that identifies the another participant to whom the chairmanship of the presently supported ad-hoc conference call is to be transferred.

6. The method of claim 3 wherein receiving a message at a conference focus network element comprises receiving a message that corresponds to a message transmitted by the initiator of the presently supported ad-hoc conference call.

7. The method of claim 6 wherein receiving a message that corresponds to a message transmitted by the initiator of the presently supported ad-hoc conference call further comprises receiving the message from a Session Initiation Protocol proxy at a conference focus network element.

8. The method of claim 6 wherein transferring chairmanship of the presently supported ad-hoc conference call comprises directing a message from the conference focus network element to the another participant of the ad-hoc conference call.

9. The method of claim 8 wherein directing a message from the conference focus network element to the another participant of the ad-hoc conference call comprises sourcing a Session Initiation Protocol-compatible message.

10. The method of claim 9 wherein the Session Initiation Protocol-compatible message comprises a Session Initiation Protocol RE-INVITE message.

11. The method of claim 10 wherein the Session Initiation Protocol RE-INVITE message comprises a header that comprises information regarding at least one of:
identification of a present chairman of the presently supported ad-hoc conference call from whom the chairmanship is to be transferred;
identification of the another participant of the presently supported ad-hoc conference call to whom the chairmanship is to be transferred;
current chairman privileges;
restrictions as correspond to a subsequent transfer of the chairmanship.

12. The method of claim 1 further comprising:
permitting the initiator of the presently supported ad-hoc conference call having a transferred chairman to leave the presently supported ad-hoc conference call having a transferred chairman without terminating the presently supported ad-hoc conference call.

13. The method of claim 12 further comprising:
permitting the initiator of the presently supported ad-hoc conference call to return to the presently supported ad-hoc conference call and, upon satisfying at least one predetermined requirement, permitting the initiator of the presently supported ad-hoc conference call to regain chairman status.

14. A Session Initiation Protocol-compatible conference FOCUS network element comprising:
a memory having stored therein identifying information from a present chairman of a presently supported ad-hoc conference call regarding another participant of the presently supported ad-hoc conference call;
a chairmanship transfer circuit operably coupled to the memory and being configured and arranged to transfer chairmanship of the presently supported ad-hoc conference call from the present chairman to the another participant.

15. The Session Initiation Protocol-compatible conference focus network element of claim 14 wherein the chairmanship transfer circuit comprises means for:
detecting an indication from the present chairman seeking to transfer the chairmanship to the another participant;
transferring chairmanship to the another participant to provide a presently supported ad-hoc conference call having a transferred chairman.

16. A method comprising:
during participation in a presently supported ad-hoc conference call as a conference call chairman:
transmitting at least one message to facilitate transferring chairmanship of the presently supported ad-hoc conference call to another participant of the presently supported ad-hoc conference call;
relinquishing the chairmanship of the presently supported ad-hoc conference call.

17. The method of claim 16 further comprising:
terminating participation in the presently supported ad-hoc conference call without thereby effecting termination of the presently supported ad-hoc conference call.

18. The method of claim 16 wherein transmitting at least one message to facilitate transferring chairmanship of the presently supported ad-hoc conference call to another participant of the presently supported ad-hoc conference call comprises transmitting a message that identifies the another participant.

19. The method of claim 16 further comprising:
during participation in a presently supported ad-hoc conference call as a conference call non-chair participant:
receiving a message indicating transfer of chairmanship of the presently supported ad-hoc conference call;
assuming chairmanship of the presently supported ad-hoc conference call.

20. The method of claim 19 wherein receiving a message indicating transfer of chairmanship of the presently supported ad-hoc conference call comprises receiving a message that comprises information regarding at least one of:
identification of a present chairman of the presently supported ad-hoc conference call from whom the chairmanship is to be transferred;
current chairman privileges;
restrictions as correspond to a subsequent transfer of the chairmanship.
